(19) United States
(12) Patent Application Publication
(10) Pub. No.: US 2010/0315608 A1
(43) Pub. Date: Dec. 16, 2010

(54) METHOD FOR CONTACT COPYING OF HOLOGRAMS AND HOLOGRAPHIC PRINTS

(76) Inventors: Stanislovas Zacharovas, Vilnius (LT); Ramunas Bakanas, Vilnius (LT); Aleksandr Pozdejev, Vilnius (LT); Andrej Nikolskij, Vilnius (LT); Evgenij Kucin, Vilnius (LT); Giedrius Gudaitis, Vilnius (LT)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/677,282

(22) PCT Filed: Sep. 2, 2008
(86) PCT No.: PCT/LT2008/000006

§ 371 Date: Mar. 9, 2010

(30) Foreign Application Priority Data
Sep. 10, 2007 (LT) 2007 056

(51) Int. Cl. G03B 27/02

(52) U.S. Cl. 355/2

(57) ABSTRACT

The invention relates to holography and is devoted for hologram copying and Denysiuk type hologram manufacture. The method comprises steps, wherein non-exposed photomaterial (1) is placed in parallel to the master hologram plane (3) and is illuminated with slit-shaped coherent radiation producing an illumination zone (5) which is parallel to the projection of the coherent radiation falling direction (6) onto the master hologram plane, said zone is moving on the non-exposed photo material and master hologram surfaces in direction (10) perpendicular to said projection.

This invention relates to the process of holography. It is devoted to a method of contact copying of holograms and holographic prints, using pulsed or continuous wave (CW) lasers. This invention may also be used to produce Denysiuk type holograms of relief objects e.g. coins, paintings etc.

A known method of contact copying holograms is described in U.S. Pat. No. 4,416,540. According to this method, the non-exposed light sensitive material is applied on a base and is positioned in parallel to the plane of the master hologram (on or beyond it). This is then illuminated with a narrow slit shape beam of coherent laser light radiation. The coherent laser radiation reconstructs the information recorded on the master hologram, i.e. becomes the object beam and the reference beam simultaneously exposing the previously non-exposed light sensitive material. As a result of the interference of these two beams, the data stored in the master hologram is recorded on the previously non-exposed light sensitive material. The zone of the master hologram illuminated by the slit shaped laser beam is perpendicular to the projection of the coherent light directed toward the surface of the master hologram. The slit zone is transported on the surface of the non-exposed light sensitive material in the direction that is parallel to the said projection of the coherent light falling direction onto the master hologram surface.

The draw back of this method in contact copying is that part of the non-exposed light sensitive material, illuminated by the object and reference light beams, remains unexposed by the object beam which carries holographic information in relation to the hologram to be copied. This occurs because the illuminated zone of the narrow slit-shaped laser radiation coherent light beam, which reconstructs the image of the master hologram and at the same time acts as the reference beam to the non exposed light sensitive material, is perpendicular to the projection of the coherent light falling direction onto the master hologram surface. Therefore, the parasitic noise, which reduces the copy quality, is always recorded together with the effective image information. This zone of the parasitic lighting increases as the distance between the master hologram and the non-exposed light sensitive material diverges and as shaper becomes an angle of incidence of coherent light beam during the contact copying. Since the master hologram per se is usually recorded on the light sensitive material and is placed on the same base, the gap between the master hologram and non-exposed light sensitive material always exists, and the angle of coherent light beam incidence might reach 15-20°.

The purpose of proposed invention is to improve the copying quality of the holograms and holographic prints and to enable the production of Denysiuk type holographic records of the relief objects (coins, paintings etc.).

This goal is achieved by the method wherein non-exposed light sensitive material, applied on a base and positioned in parallel to the plane of the master hologram or the holographic print is illuminated by a slit-shaped beam of coherent laser radiation in such a way that the previously non-exposed zone, illuminated by this beam, is parallel to the projection of the coherent light falling direction onto the plane of master hologram or the holographic print, and this zone is transported on the surface of non-exposed light sensitive material and on the surface of master hologram or holographic print in the direction, which is perpendicular to the projection of the coherent light beam (which illuminates hologram or holographic print and reconstructs its image information) falling direction onto the surface planes of the materials mentioned.

The length of the zone illuminated by the narrow slit-shaped laser radiation beam, at the location where this beam falls onto the light sensitive material is at least 1% longer than the length of the master hologram and the length of the non-exposed light sensitive material.

The laser radiation beam optionally has a shape of narrow oblong rectangular or the elongated oval.

The laser radiation might optionally be pulsed, and the radiation energies distribution might optionally have [symbol] shape.

Besides, illumination of material to be copied might be performed by multiple colours coherent radiations simultaneously. As well illumination of material to be copied might be performed by different colour coherent radiations successively. The proposed method is helpful in improving the copying quality of the holograms and holographic prints and allows holographic copying of the relief objects (coins, paintings etc.) producing Denysiuk type holograms.

The proposed method is explained by drawings, in which:

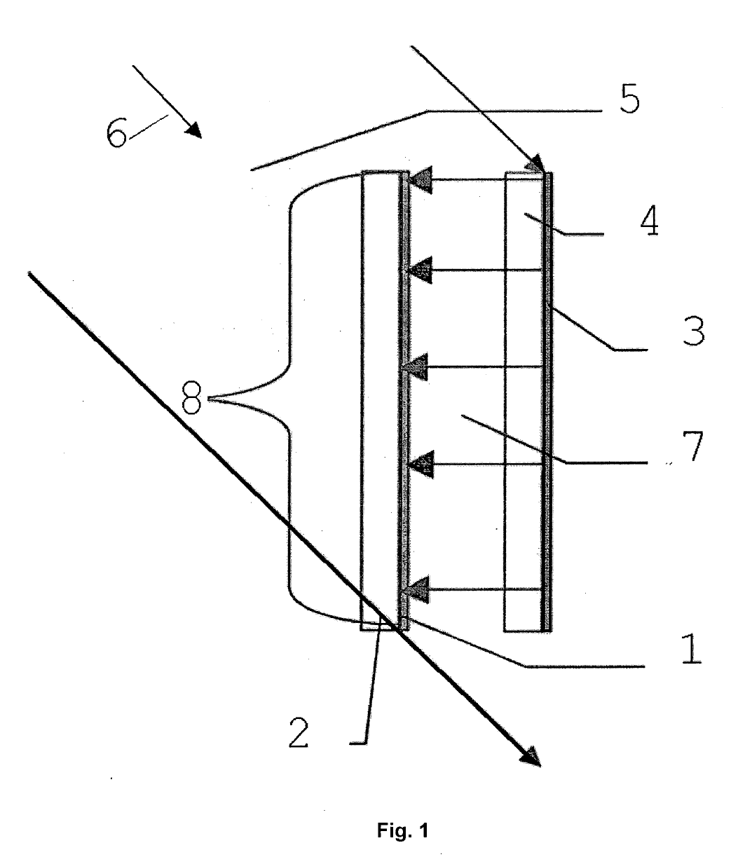

FIG. 1 shows the scheme of the proposed hologram copying method (side view);

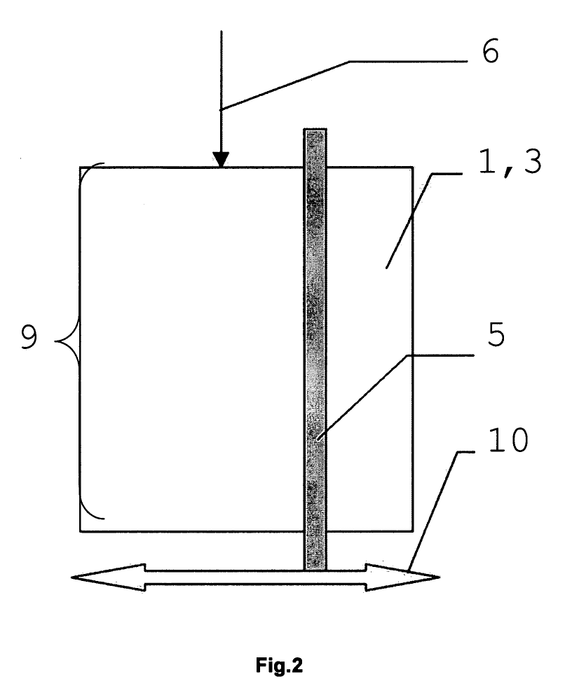

FIG. 2 shows the scheme of the proposed hologram copying method (front view);

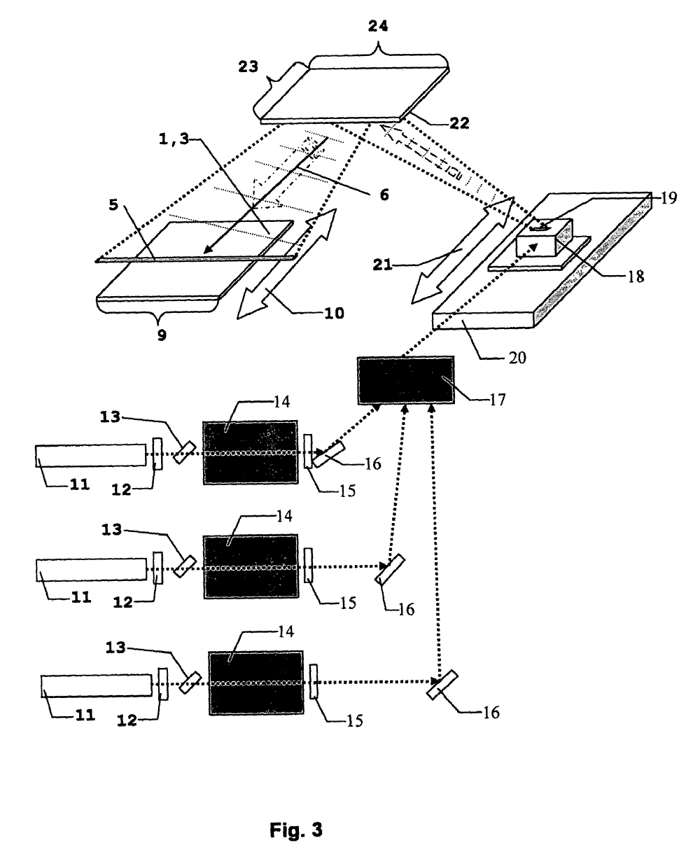

FIG. 3 shows the scheme of the proposed hologram copying apparatus.

The proposed method comprises following steps:
non-exposed light sensitive material 1, applied on the solid or flexible, transparent or non transparent base 2, is placed either on or beyond the master hologram or holographic print 3, placed on the base 4 in such a way that the planes of all the surfaces would be parallel to each other (FIG. 1);
non-exposed light sensitive material 1 and the master hologram or holographic print 3 are lightened with the slit-shaped coherent laser radiation beam 5 that is falling to the master hologram or holographic print 3 in direction 6 and the information recorded on the master hologram is reconstructed (FIG. 1, position 7);
on the non-exposed light sensitive material this image interferes with coherent laser radiation, that induced it, and on this light sensitive material the copy of the hologram or holographic print is recorded (FIG. 1, position 8);
the zone 5, illuminated by slit-shaped coherent laser radiation beam is parallel to the lighting direction 6 projection onto the plane of the master hologram 3 surface;
the lighting direction 6 is chosen in such a way that maximum brightness of the reconstructed image of the master hologram would be perpendicular to the master hologram plane;
the zone 5 illuminated by the slit-shaped coherent laser radiation on the master hologram is at least 1% longer than the length of the master hologram or holographic print 3 and the length 9 of the non-exposed light sensitive material 1;
the zone 5 enforced to move continuously in the direction 10, which is perpendicular to the projection of the coherent light falling direction 6 onto the plane of the master hologram or holographic print 3.

In the apparatus (FIG. 3) designated for implementation of this copying method, pulsed lasers 11 are employed as the coherent radiation sources. These lasers have three different wavelengths: in the range of red, green and blue color spectrum.

Further, in the direction of the laser 11 radiation, there are arranged: rotating computer controlled wave plates 12, polarizers 13, telescopic laser radiation beam cleaners—spatial filters 14, polarization correctors 15, mirrors 16 and three colours combiner-deflector 17. Further, on the way of the radiation beam there is a beam formation/deflection system 18, which has the device for the beam shaping into the form of narrow oblong rectangular or elongated oval slits 19.

Shaping/deflection system 18 is fixed on the computer controlled translation motion mover 20. This mover is able to move to the direction 21.

The beam, formed with shaping/deflection system 18, falls onto the mirror 22, which is placed in such a way, that the beam reflected by the mirror 22, would fall onto the non-exposed transparent light sensitive material 1 in the direction 6, to obtain illuminated zone 5 parallel with the lighting direction 6 of the master hologram 3, and seeking to reproduce the master hologram image in such a way that the maximum brightness of this image would be perpendicular to the plane of the master hologram 3 surface.

The width 23 of the mirror 22 is chosen in such a way, that the zone 5, obtained by reflecting the coherent radiation beam from said mirror, would illuminate the desirable area of the master hologram 3 by moving this beam with the mover 20 of translation motion. At the same time the beam of the coherent radiation exposes needed area of the non-exposed light sensitive material 1.

The length 24 of the mirror 22 is chosen in such a way, that the length of illuminated zone 5, obtained by reflecting the coherent radiation beam from said mirror, would be at least 1% longer than the length of the master hologram 3 and the length 9 of the non exposed light sensitive material 1.

The method is to be implemented in following way.

The wavelength of the each of the radiations generated by lasers 11 has to match wavelengths of the spatial image formed by the coloured (or monocolor) master hologram or holographic print 3. The computer-controlled wave plates 12 and polarizers 13 adjust colour balance.

The laser 11 beams then are deterged with the telescopic laser beam cleaners—spatial filters 14. The polarization correctors 15 compensate spatial filters 14 polarization.

Then the beams by the mirrors 16 are directed to the three-colour combiner-deflector 17.

The beams from the combiner-deflector 17 are heading the same direction and way, directed to the laser radiation beam shaping/deflection system 18. This system forms laser radiation beam into shape of the narrow oblong rectangular (or the elongated oval) slit 19. Then beam, reflected by flat or other form mirror 22, falls onto the non-exposed light sensitive material 1 and onto the master hologram or holographic print 3.

The width 23 of the mirror 22 is chosen in such a way, that coherent radiation beam reflected by it formed the illuminated zone 5, which would illuminate the necessary area of the master hologram or holographic print 3 and would expose the necessary area of the non exposed light sensitive material 1 by moving this zone 5 with the translation motion mover 20. The length 24 of the mirror 22 is chosen in such a way, that the length of zone 5 illuminated by coherent radiation beam reflected by said mirror, would be at least 1% longer than the length of the master hologram or holographic print 3 and the length 9 of the non exposed light sensitive material 1.

The slit-shaped laser radiation falls onto the non-exposed light sensitive material 1, which is coated on the flexible or solid flat base and is placed on or beyond the master hologram or holographic print 3 to be copied. The laser radiation beam 5 is going in direction 6 in such a way, that the illuminated zone 5 would be parallel to the projection of the master hologram or holographic print 3 illuminating direction 6 to the master hologram 3 plane.

The laser radiation shaping/deflection system 18 is fixed on the computer controlled translation motion mover 20, which assures its even movement in direction 21. At the same time the translation motion mover 20 assures the coherent light radiation movement in direction 10, which is perpendicular to the projection of the coherent lighting beam that illuminates the master hologram, falling direction 6 to the master hologram plane. This assures the even exposure of non-exposed light sensitive material and master hologram, causing the even recording of reconstructed master hologram data.

The proposed method is helpful in improving the copying quality of the holograms and holographic prints and allows holographic copying of the relief objects (coins, paintings etc.) producing Denysiuk type holograms.

1. A method of contact copying of holograms and holographic prints, wherein a non-exposed light sensitive material (1), applied on a base and positioned in parallel to a plane of master hologram or holographic print (3), is illuminated by a slit-shaped coherent laser radiation beam, and an illuminated zone is forced to move on a surface of the non-exposed light sensitive material (1), characterized in that the slit-shaped coherent laser radiation beam is directed to obtain the non-exposed light sensitive material (1) zone (5), illuminated by the laser radiation beam, being parallel to the projection of coherent light falling direction (6) onto the plane of the master hologram or holographic print (3) surface and zone (5) is forced to move on the surfaces of the non-exposed light sensitive material (1) and of the master hologram or the holographic print (3) in a direction (10), which is perpendicular to the coherent light beam, illuminating master hologram or holographic print (3) and is reconstructing its image information, falling direction projection to the surface planes of the mentioned materials.

2. The method, according to claim 1, characterized in that the slit-shaped laser radiation beam is formed to have length of the illuminated zone (5) at the location where this beam falls onto the light sensitive material (1), at least 1% longer than the length of the master hologram or holographic print (3).

3. The method, according to claim 2, characterized in that the slit-shaped laser radiation beam has a shape of narrow rectangular or the elongated oval.

4. The method, according to claim 1, characterized in that illumination of material to be copied (3) is performed by multiple color coherent radiations simultaneously.

5. The method, according to claim 1, characterized in that illumination of material to be copied (3) is performed by different color coherent radiations successively.

6. The method, according to claim 1, characterized in that the laser radiation is pulsed, and the radiation energies distribution has optionally [symbol] shape.
